(19) United States
(12) Patent Application Publication
(10) Pub. No.: US 2025/0068902 A1
(43) Pub. Date: Feb. 27, 2025

(54) MODEL SEARCH AND OPTIMIZATION

(71) Applicant: International Business Machines Corporation, Armonk, NY (US)

(72) Inventors: Long VU, Chappaqua, NY (US); Dharmashankar Subramanian, Rye Brook, NY (US); Radu Marinescu, Dublin (IE)

(21) Appl. No.: 18/453,401

(22) Filed: Aug. 22, 2023

(51) Int. Cl. G06N 3/08

(52) U.S. Cl. CPC G06N 3/08

(57) ABSTRACT

Methods and systems for tuning a model include generating pipelines. The pipelines have elements that include at least an agent, a foundation model, and a tuning type. Hyperparameters of elements of the pipelines are set in accordance with an input task. Elements of the pipelines are tuned in accordance with the input task. The input task is performed using a highest-performance pipeline.

### BACKGROUND

The present invention generally relates to machine learning systems and, more particularly, to tuning a foundation model with search and hyperparameter optimization.

Machine learning systems, such as natural language models, are trained with a corpus of training examples. In some cases, the training corpus may be made up of generic text, with no specific domain being contemplated. However, specific tasks may benefit from aligning the model with a particular domain. Furthermore, the method of training the model may be selected to improve its performance for specific tasks. However, it can be challenging to predict what domain and type of tuning will be needed.

### SUMMARY

A method for tuning a model includes generating pipelines. The pipelines have elements that include at least an agent, a foundation model, and a tuning type. Hyperparameters of elements of the pipelines are set in accordance with an input task. Elements of the pipelines are tuned in accordance with the input task. The input task is performed using a highest-performance pipeline.

A system for tuning a model includes a hardware processor and a memory that stores a computer program. When executed by the hardware processor, the computer program causes the hardware processor to generate pipelines. The pipelines have elements that include at least an agent, a foundation model, and a tuning type. Hyperparameters of elements of the pipelines are set in accordance with an input task. Elements of the pipelines are tuned in accordance with the input task. The input task is performed using a highest-performance pipeline.

A method for tuning a model includes performing an outer search of pipelines according to a performance metric defined by an input task. Each pipeline has elements that include at least an agent, a foundation model, and a tuning type, and at least one of pipelines additionally has a reward model element. The outer search is performed over a space with dimensions defined by the elements of the pipelines. For each pipeline identified by the outer search, an inner search is performed for parameters corresponding to the elements of the identified pipeline in accordance with the performance metric to optimize the identified pipeline for the input task. The input task is performed using a highest-performing tuned pipeline of the identified pipelines according to the performance metric.

A system for tuning a model includes a hardware processor a memory that stores a computer program. When executed by the hardware processor, the computer program causes the hardware processor to perform an outer search of pipelines according to a performance metric defined by an input task. Each pipeline has elements that include at least an agent, a foundation model, and a tuning type. At least one of pipelines additionally has a reward model element, over a space with dimensions defined by the elements of the plurality of pipelines. For each pipeline identified by the outer search, an inner search is performed for parameters corresponding to the elements of the identified pipeline in accordance with the performance metric to optimize the identified pipeline for the input task. The input task is performed using a highest-performing tuned pipeline of the identified pipelines according to the performance metric.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram of a method/system for tuning and using a machine learning model with a pipeline search, in accordance with an embodiment of the present invention;

FIG. 2 is a block diagram of a multi-level pipeline search that includes an outer search across pipelines and an inner search that optimizes parameters of the pipelines, in accordance with an embodiment of the present invention;

FIG. 3 is a block/flow diagram of a method of performing an inner search that tunes hyperparameters of a pipeline, in accordance with an embodiment of the present invention;

FIG. 4 is a diagram of a search tree used in an outer search to identify pipelines, in accordance with an embodiment of the present invention;

FIG. 5 is a block diagram showing the use of a tuned model to process input text and to generate a responsive action, in accordance with an embodiment of the present invention;

FIG. 6 is a block diagram of a computer system that can tune and use a model, in accordance with an embodiment of the present invention;

FIG. 7 is a block diagram of a neural network model that may be used to implement part of a tuned model, in accordance with an embodiment of the present invention;

FIG. 8 is a block diagram of a deep neural network model that may be used to implement part of a tuned model, in accordance with an embodiment of the present invention.

### DETAILED DESCRIPTION

A foundation model in a machine learning system may be dynamically tuned using a unified framework that finds the best options for any appropriate task. A set of different foundation models, reinforcement learning agents with different tunable hyperparameters, and tuning types may be searched to generate one or more top-performing tuning pipelines based on a given input task. For example, each pipeline may include an agent, a foundation model, a tuning type, and optionally a reward model definition.

The search for an optimal pipeline may include an outer search and an inner search. The outer search searches across the different pipeline combinations to select a set of pipelines appropriate to the task. The inner search performs hyperparameter optimization on the agents, tuning the selected foundation model with the selected tuning type and reward model using a performance metric obtained by the tuned foundation model. One or more appropriate pipelines may be output, ranked by the performance of the tuned foundation models on the input task.

The unified framework for model selection and optimization therefore includes searching across multiple reinforcement learning agents, reinforcement models, and reward models, and applying different types of tuning, for example the option of supervised data and reinforcement learning. The tuning may be implemented as a multi-level search and hyperparameter optimization.

For reinforcement learning agents, an augmented foundation model may be used as a policy function. Such augmented foundation models may be implemented with fractional fine tuning, where only a fraction of a policy network's weights are updated during back propagation, with the fraction being treated as a hyperparameter. Such augmented foundation models may alternatively be implemented with prepended layers in prefix tuning. The original foundation model may be frozen while the prepended layers are updated during back propagation.

Interaction between the reinforcement learning agent and the pretrained foundation model may also be enabled, providing an environment to optimize the hyperparameters of the reinforcement learning agent. Although the foundation model may remain unchanged during this optimization, the reinforcement agent is nonetheless tuned. A performance metric of the tuned foundation model may be used to find the optimized hyperparameter configurations of the reinforcement learning agent at the inner search level and to rank the pipelines in the outer search level.

Methods and systems for tuning a model include generating pipelines. The pipelines have elements that include at least an agent, a foundation model, and a tuning type. Hyperparameters of elements of the pipelines are set in accordance with an input task. Elements of the pipelines are tuned in accordance with the input task. The input task is performed using a highest-performance pipeline. The tuning automatically generates a model suitable for a new task, so that the task can be performed efficiently by a computer system without manual construction of a pipeline.

The elements of at least one pipeline of the plurality of pipelines may further include a reward model. The inclusion of a reward model expands the number of possible pipelines, thereby improving the efficiency of a tuned model for which the reward model is appropriate.

The agent of at least one pipeline may be a pass-through agent that corresponds with supervised tuning of the foundation model. The use of a pass-through agent makes it possible to incorporate pipelines with supervised training, where the use of a reinforcement learning agent might not be appropriate.

Generating the pipelines may include performing a search over a space, with dimensions of the space defined by the elements of the plurality of pipelines. Searching this space makes it possible to generate a variety of different pipelines responsive to the needs of a particular input task.

Performing the search may include varying the elements of the pipelines in accordance with a performance metric of the input task. This variation makes it possible to perform the search by considering different options for the pipeline elements.

Performing the search may include performing a limited discrepancy search over a tree, where the tree includes a set of levels that correspond to respective elements of the plurality of pipelines.

Generating the pipelines includes selecting, for each of the plurality of pipelines, a tuning type from a group that includes at least prefix tuning, fine tuning, and fractional tuning. Having multiple tuning types makes it possible to generate pipelines that are well suited to the needs of the input task.

Generating the pipelines includes selecting, for each of the plurality of pipelines, an agent from a group that includes at least advantage actor-critic (A2C), proximal policy optimization (PPO), trust region policy optimization (TRPO), and a pass-through agent. Having multiple agent types makes it possible to generate pipelines that are well suited to the needs of the input task.

Generating the plurality of pipelines includes selecting, for each of the plurality of pipelines, a foundation model from a group that includes at least a text-to-text transfer transformer (T5) model, a generative pre-trained transformer (GPT) model, a BigScience Large Open-science Open-access Multilingual Language (BLOOM) model, and a fine-tuned language net (FLAN) model. Having multiple foundation models makes it possible to generate pipelines that are well suited to the needs of the input task.

Methods and systems for tuning a model include performing an outer search of pipelines according to a performance metric defined by an input task. Each pipeline has elements that include at least an agent, a foundation model, and a tuning type, and at least one of pipelines additionally has a reward model element. The outer search is performed over a space with dimensions defined by the elements of the pipelines. For each pipeline identified by the outer search, an inner search is performed for parameters corresponding to the elements of the identified pipeline in accordance with the performance metric to optimize the identified pipeline for the input task. The input task is performed using a highest-performing tuned pipeline of the identified pipelines according to the performance metric. The hierarchical search, including the outer search and inner search, automatically generates a model suitable for a new task, so that the task can be performed efficiently by a computer system without manual construction of a pipeline.

The inner search may include tuning the foundation model for the identified pipeline according to a set of training data, the tuning type for the identified pipeline, and according to one or more hyperparameters. This inner search tunes the pipeline to generate the best performance it can provide for the input task.

The inner search may include tuning the agent for the identified pipeline according to a set of training data and a reward model that guides the agent's behavior. This inner search tunes the pipeline to generate the best performance it can provide for the input task.

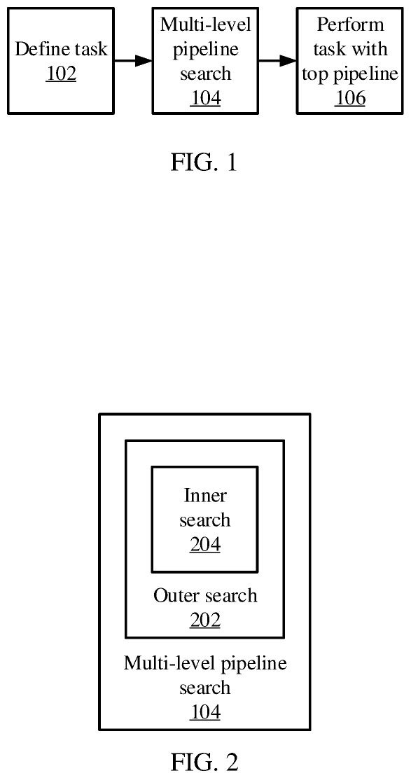

Referring now to FIG. 1, a method for selecting and tuning a model for a task is shown. Block 102 defines the task. Exemplary tasks may include text summarization, text generation, and text classification. The task may include a metric to evaluate the performance of the task, such as using a text similarity measure to compare text produced by a pipeline against a ground truth label. Such metrics may be highly task-specific, and so are included in the definition of the task.

A multi-level pipeline search 104 is performed to identify one or more pipelines that are effective for use in performing the task. The search 104 evaluates multiple different combinations of foundation models, reinforcement learning agents, tuning types, and optional reward policies to find a combination that performs best for the task. The search 104 includes hyperparameter optimization to provide a pipeline that is already suitable for use in the task. The task is then performed 106 using the best pipeline result from the search 104.

For example, a new task can be given a list of tables, with table column names in a text format. For each column, the task may be to output a paragraph that describes the column. The task can be formulated as a text generation problem. A training set for the task can be created with multiple training samples, each sample including a column name and a textual description of the column. A large language model can be used to tune the task for the training set. The tuned model will produce the text description for the input column name, with a reward model being, for example, the cosine similarity between the predicted text description of the column name and the ground truth text description.

Referring now to FIG. 2, additional detail is provided for the multi-level pipeline search 104. The search 104 includes a nested, bi-level tuning system. The outer search 202 searches across reinforcement learning agents and the inner search 204 searches, for each such agent, for optimized hyperparameter configurations, at the same time tuning the foundation model with a selected tuning type. A performance metric on a validation set obtained by the tuned foundation model can be used to guide the search for optimized configurations for an agent in the inner search 204, as well as the search across agents in the outer search 202.

The outer search 202 may be provided with a set of different reinforcement learning agents. The agents may include, for example, advantage actor-critic (A2C), proximal policy optimization (PPO), trust region policy optimization (TRPO), a pass-through agent that tunes the foundation model directly with supervised data and no reward model, and any other appropriate agent type. The outer search 202 may further have access to a set of different pretrained foundation models, such as a text-to-text transfer transformer (T5) model, a generative pre-trained transformer (GPT) model, a BigScience Large Open-science Open-access Multilingual Language (BLOOM) model, a fine-tuned language net (FLAN) model, and any other appropriate model type. The outer search 202 may further have access to a set of different tuning types, such as prefix tuning, prompt tuning, fine tuning, and any other appropriate tuning type. The outer search 202 may further have access to a set of different reward models, to be used in pipelines that make use of reinforcement learning (e.g., using an agent other than the pass-through agent). The outer search 202 outputs a predetermined number of the top pipelines.

Each task may have an associated metric for evaluating the task's performance. The performance of a pipeline with respect to this metric, on a given validation data set, may be used to determine which pipeline delivers superior performance. The performance metric may be treated as guidance for the search, for example maximizing the performance metric as the objective of the search. The search in this case aims to select pipelines, by changing hyperparameters, reward functions, tuning types, etc., to find better performing configurations and pipelines.

The pipelines may be generated in advance, for example by an exhaustive brute-force enumeration, or may be created at runtime using any appropriate search, such as a limited discrepancy search. The limited discrepancy search may cross four different dimensions, identified as the agents, the foundation models, the tuning types, and the reward models (if any). The search may iteratively generate pipelines from the search space by generating a tree structure, with each level of the tree structure corresponding to a different dimension.

The optimizations and tuning performed by the inner search 204 will vary among the pipelines generated by the outer search 202. For example, the foundation model may be tuned using a supervised dataset. In this instance, the pipeline may include the pass-through agent, any appropriate foundation model, prefix tuning or fine tuning, and no reward model. The inner search 204 will output the tuned foundation model according to the selected tuning type for this pipeline.

The foundation model may be augmented by prepending it with prefix layers and/or configuring it so that a fraction of its weights will be updated during training. For each training epoch, a batch of training data may be created. Back propagation may then be used to update the appropriate weights of the foundation model. The tuned foundation model may then be used to calculate performance metrics, such as win rate, truthfulness, informativeness, and toxicity.

These performance metrics may be used as guidance for the outer search 202, with the objective of maximizing the relevant performance metric. The outer search 202 changes pipeline configurations, such as by changing options in the hyperparameters, reward function, tuning types, etc., to identify pipelines with good performance. Pipelines are compared to one another in the outer search 202, while the inner search 204 changes hyperparameters of specific pipelines.

In instances where the pipeline includes a reinforcement learning model (e.g., other than the pass-through agent), reward models may be trained. The inner search 204 collects labeled data sets, for example by assigning labels to text data (e.g., manually or in an automated fashion) and assigning rankings to different text snippets. Alternatively, labeled data sets can be generated by a predefined function or simulator. The model reward function may include a loss function for specific input tasks. The reward model may be trained, and different tasks may need different reward models and loss functions. The reward model may be constrained such that the tuned foundation model does not drift too far from the original foundation model.

The loss function may include the cross-entropy loss or any other appropriate loss function, including a user-defined loss function. For a given input prompt, the reward model may be constrained by checking whether the reward scalar for the current training iteration is significantly different from the reward scalar from a previous training iteration (e.g., with a difference value above a threshold). If so, then the next action may be limited, for example only updating the new reward scalar by a relatively small amount from the last reward scalar.

When optimizing with prefix tuning, the foundation model is augmented by additional neural network layers, for example by prepending the original network. During tuning, the original foundation model part is frozen and its weights are not updated, while the additional layers are trained. Two forms of such prefix training may be performed. With a pass-through agent, the augmented foundation model can be trained using the supervised training described above. With a reinforcement learning agent, the foundation model implements a policy network, with weights being updated (as appropriate) with regard to the interaction between the agent and the reward model. When tuning the foundation model with a reinforcement learning agent, fractional tuning can be performed, where only a fraction of the weights of the foundation model are updated.

Some exemplary language tasks may include error detection and imputation. In these tasks, a reinforcement learning agent may be trained using the foundation model as the environment. In a pipeline for such a task, the pretrained model may not be tuned or updated. The reinforcement learning agent improves input prompts using sequential interactions with the foundation model and makes choices based a reward model. The reinforcement learning model generates new prompts for a next interaction based on the outputs of the foundation model and learns how to generate improved prompts. The present framework performs hyperparameter optimization on the reinforcement learning agents to find the one that performs best for the task. In this case, the output of the system includes the optimized reinforcement learning agent that can provide the best prompts for the task.

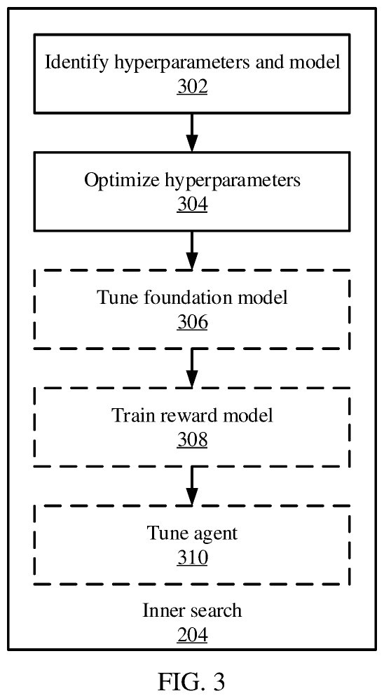

Referring now to FIG. 3, additional detail on the inner search 204 is shown. The inner search 204 accepts as input a pipeline from the outer search 202, which may include a reinforcement learning agent, a foundation model, a type of tuning and a reward model. Block 302 identifies the hyperparameters and model elements are called for by the input pipeline. Block 304 optimizes the hyperparameters according to any appropriate tuning process. The tuning processes performed by the inner search will depend on the particular combination of elements in the selected pipeline.

For example, in some cases the inner search 204 may tune the foundation model in block 306, while in others the foundation model may remain static. In some cases the inner search 204 may train the reward model in block 308, while in other cases there may be no reward model at all. In some cases the inner search 204 may tune a reinforcement agent in block 310, while in other cases the agent may be designated as a pass-through.

The reward model that is optionally trained in block 308 can be a large language model that receives text prompts as input and produce a scalar reward value as output. Alternatively, a reward model can be any machine learning model that accept text string as input, producing a scalar or float value as output. The reward model can also be as simple as the cosine similarity measurement on predicted text produced by the model being a tuned large language model against ground truth text.

The search function may be expressed as a function, where each input to the function is a hyperparameter. Exemplary hyperparameters include learning rate, batch size, and discount factor, each of which has its own domain. The search seeks to maximize the value of the function by varying the hyperparameters, identifying the best-tuned language model for the input task's performance metric.

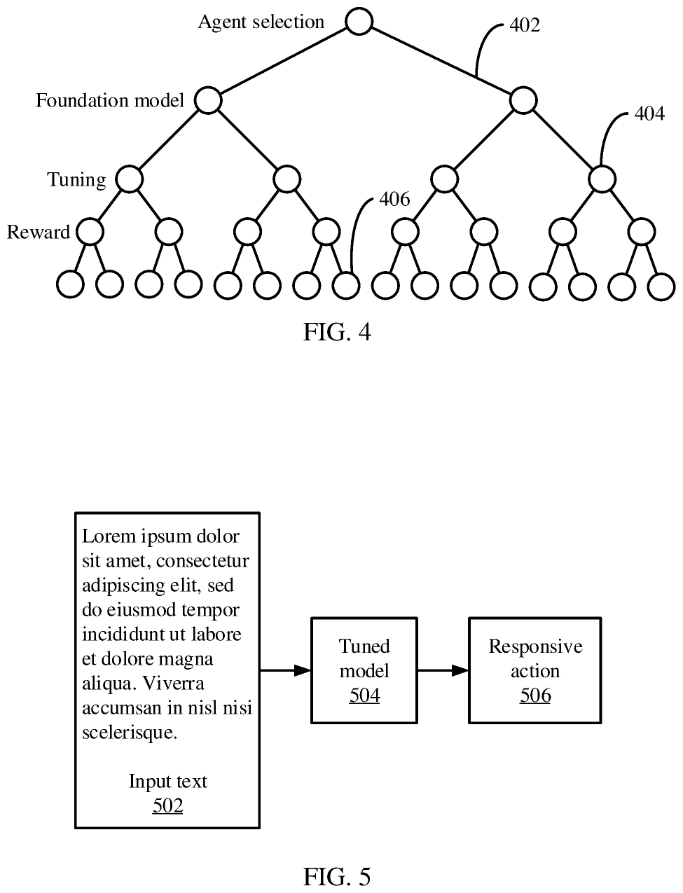

Referring now to FIG. 4, additional detail on the selection of a pipeline in the outer search 202 is shown. A search tree is illustrated, where each level of the tree represents a different decision to be made in the construction of a pipeline. The tree is made up of interior 404 that represent partial pipelines and leaf nodes 406 that represent completed pipelines.

For example, the first level of the tree may represent agent selection. Outer search 202 selects one of the available options for reinforcement learning agents by traversing an edge 402 of the tree. At the next level, in this case foundation model selection, outer search 202 makes a selection by traversing another edge 402. Another selection is made at each interior node 404 until a leaf node 406 is reached and a complete pipeline is output.

During the outer search 202, an exhaustive search may traverse every possible path through the tree to generate a set of pipelines, for example by iteratively traversing the tree and selecting a different path on each iteration until every path has been traversed. In some cases, particular paths of the tree may be excluded from the search for a given task, for example based on known requirements of the input task. With a large search space, when an exhaustive search is not needed, generating all of the pipelines in advance may not be feasible. In such cases, pipelines may be determined responsive to the task, navigating the search space in accordance with results from the task's performance metric.

The reward models may be learned from labeled data or may be automatically generated by another language model or by a simulator. In some cases the reward function may be a predefined function. In some cases the reward models may accept a query and a response as inputs and may generate a scalar reward value. A given input task may have multiple applicable reward models.

Referring now to FIG. 5, use of the tuned model is illustrated. A new input text 502 is provided as input to the tuned model 504. The tuned model 504 may be based on any appropriate foundation model, and may have been tuned according to any appropriate task that is to be performed on the input text 502. For example, the tuned model 504 may perform a text classification task, such as sentiment recognition, translation, or text summarization, generating an output appropriate to the task and the input.

Based on the output of the tuned model 504, block 506 performs a responsive action. The responsive action may, for example, generating responsive text. In one particular example, the task may be a question and answer task, where the tuned model 504 identifies a topic of interest from the input text 502 and the responsive action 506 generates text relating to the topic of interest. In such an example, the responsive action 506 may include a language model of its own to generate the appropriate text. In another example, the task may convert a natural language input text 502 into a set of commands for a computer system, and the responsive action 506 may include executing those commands.

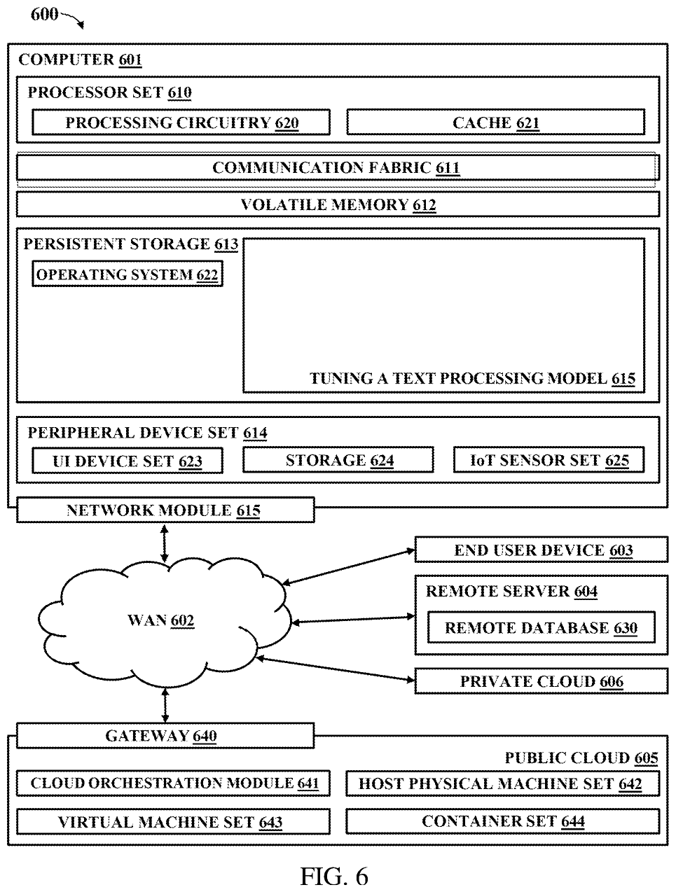

Referring now to FIG. 6, a computer system 601 is shown. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as tuning a text processing model 615. In addition to block 615, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

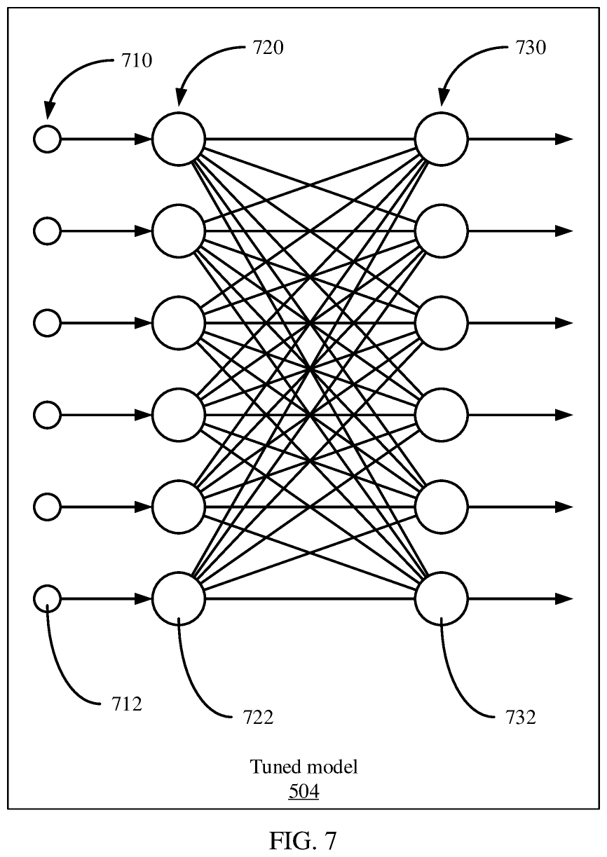

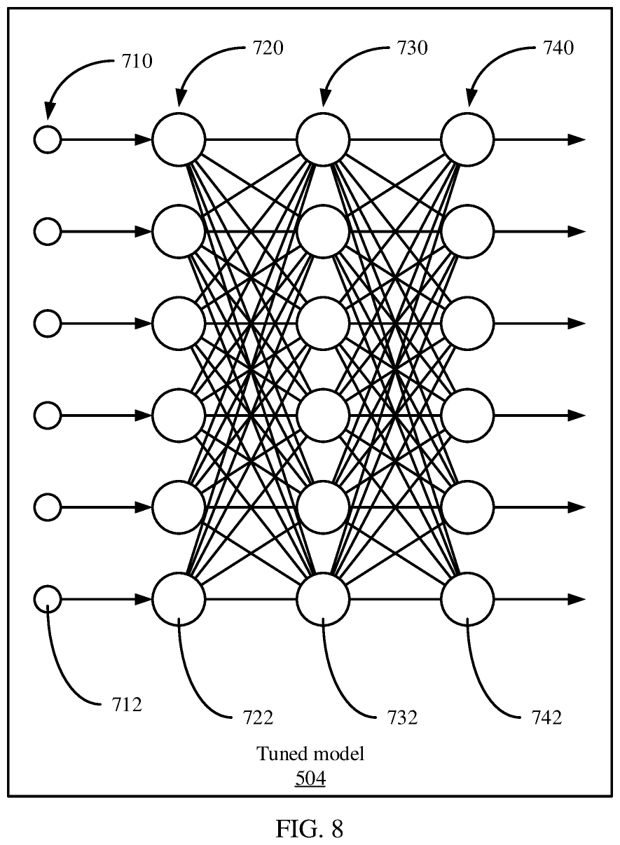

Referring now to FIGS. 7 and 8, exemplary neural network architectures are shown, which may be used to implement parts of the present models, such as tuned model 504. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of model search and optimization (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for tuning a model, comprising:
generating a plurality of pipelines, with elements that include at least an agent, a foundation model, and a tuning type;
setting hyperparameters of elements of the plurality of pipelines in accordance with an input task;
tuning elements of the plurality of pipelines in accordance with the input task; and
performing the input task using a highest-performance pipeline of the plurality of pipelines.

2. The method of claim 1, wherein the elements of at least one pipeline of the plurality of pipelines further includes a reward model.

3. The method of claim 1, wherein the agent of at least one pipeline of the plurality of pipelines is a pass-through agent that corresponds with supervised tuning of the foundation model.

4. The method of claim 1, wherein generating the plurality of pipelines includes performing a search over a space, with dimensions of the space defined by the elements of the plurality of pipelines.

5. The method of claim 4, wherein performing the search includes varying the elements of the pipelines in accordance with a performance metric of the input task.

6. The method of claim 4, wherein performing the search includes performing a limited discrepancy search over a tree, where the tree includes a set of levels that correspond to respective elements of the plurality of pipelines.

7. The method of claim 1, wherein generating the plurality of pipelines includes selecting, for each of the plurality of pipelines, a tuning type from a group that includes at least prefix tuning, fine tuning, and fractional tuning.

8. The method of claim 1, wherein generating the plurality of pipelines includes selecting, for each of the plurality of pipelines, an agent from a group that includes at least advantage actor-critic (A2C), proximal policy optimization (PPO), trust region policy optimization (TRPO), and a pass-through agent.

9. The method of claim 1, wherein generating the plurality of pipelines includes selecting, for each of the plurality of pipelines, a foundation model from a group that includes at least a text-to-text transfer transformer (T5) model, a generative pre-trained transformer (GPT) model, a BigScience Large Open-science Open-access Multilingual Language (BLOOM) model, and a fine-tuned language net (FLAN) model.

10. A system for tuning a model, comprising:
a hardware processor; and
a memory that stores a computer program which, when executed by the hardware processor, causes the hardware processor to:
generate a plurality of pipelines, with elements that include at least an agent, a foundation model, and a tuning type;
set hyperparameters of elements of the plurality of pipelines in accordance with an input task;
tune elements of the plurality of pipelines in accordance with the input task; and
perform the input task using a highest-performance pipeline of the plurality of pipelines.

11. The system of claim 10, wherein the elements of at least one pipeline of the plurality of pipelines further includes a reward model.

12. The system of claim 10, wherein the agent of at least one pipeline of the plurality of pipelines is a pass-through agent that corresponds with supervised tuning of the foundation model.

13. The system of claim 10, wherein the computer program further causes the hardware processor to perform a search over a space, with dimensions of the space defined by the elements of the plurality of pipelines, as part of the generation of the plurality of pipelines.

14. The system of claim 13, wherein the search includes variation of the elements of the pipelines in accordance with a performance metric of the input task.

15. The system of claim 10, wherein the computer program further causes the hardware processor to perform a limited discrepancy search over a tree, where the tree includes a set of levels that correspond to respective elements of the plurality of pipelines.

16. The system of claim 10, wherein the computer program further causes the hardware processor to select, for each of the plurality of pipelines, a tuning type from a group that includes at least prefix tuning, fine tuning, and fractional tuning.

17. The system of claim 10, wherein the computer program further causes the hardware processor to select, for each of the plurality of pipelines, an agent from a group that includes at least advantage actor-critic (A2C), proximal policy optimization (PPO), trust region policy optimization (TRPO), and a pass-through agent.

18. The system of claim 10, wherein the computer program further causes the hardware processor to select, for each of the plurality of pipelines, a foundation model from a group that includes at least a text-to-text transfer transformer (T5) model, a generative pre-trained transformer (GPT) model, a BigScience Large Open-science Open-access Multilingual Language (BLOOM) model, and a fine-tuned language net (FLAN) model.

19. A computer program product for tuning a model, the computer program product comprising a computer readable storage medium having program instructions embodied therewith, the program instructions being readable by a hardware processor to cause the hardware processor to:
generate a plurality of pipelines, with elements that include at least an agent, a foundation model, and a tuning type;
set hyperparameters of elements of the plurality of pipelines in accordance with an input task;
tune elements of the plurality of pipelines in accordance with the input task; and
perform the input task using a highest-performance pipeline of the plurality of pipelines.

20. A computer-implemented method for tuning a model, comprising:
performing an outer search of a plurality of pipelines according to a performance metric defined by an input task, each having elements that include at least an agent, a foundation model, and a tuning type, and with at least one of the plurality of pipelines additionally having a reward model element, over a space with dimensions defined by the elements of the plurality of pipelines;
for each pipeline identified by the outer search, performing an inner search for parameters corresponding to the elements of the identified pipeline in accordance with the performance metric to optimize the identified pipeline for the input task; and
performing the input task using a highest-performing tuned pipeline of the identified pipelines according to the performance metric.

21. The method of claim 20, wherein the inner search comprises tuning the foundation model for the identified pipeline according to a set of training data, the tuning type for the identified pipeline, and according to one or more hyperparameters.

22. The method of claim 20, wherein the inner search comprises tuning the agent for the identified pipeline according to a set of training data and a reward model that guides the agent's behavior.

23. A system for tuning a model, comprising:
a hardware processor; and
a memory that stores a computer program which, when executed by the hardware processor, causes the hardware processor to:
perform an outer search of a plurality of pipelines according to a performance metric defined by an input task, each having elements that include at least an agent, a foundation model, and a tuning type, and with at least one of the plurality of pipelines additionally having a reward model element, over a space with dimensions defined by the elements of the plurality of pipelines;
for each pipeline identified by the outer search, perform an inner search for parameters corresponding to the elements of the identified pipeline in accordance with the performance metric to optimize the identified pipeline for the input task; and
perform the input task using a highest-performing tuned pipeline of the identified pipelines according to the performance metric.

24. The system of claim 23, wherein computer program further causes the hardware processor to tune the foundation model for the identified pipeline according to a set of training data. and the tuning type for the identified pipeline, and one or more hyperparameters as part of the inner search.

25. The system of claim 23, wherein the computer program further causes the hardware processor to tune the agent for the identified pipeline according to a set of training data and a reward model that guides the agent's behavior as part of the inner search.
